(19) United States
(12) Patent Application Publication
(10) Pub. No.: US 2020/0087929 A1
(43) Pub. Date: Mar. 19, 2020

(54) SHOE MOLDING WITH CASING JUNCTION

(71) Applicant: David Groff, Manheim, PA (US)

(72) Inventor: David Groff, Manheim, PA (US)

(21) Appl. No.: 16/134,119

(22) Filed: Sep. 18, 2018

(51) Int. Cl. E04F 19/04; E04F 19/06; E06B 1/00

(52) U.S. Cl. CPC E04F 19/04; E04F 19/061; E06B 1/52; E04F 2019/0454; E06B 1/006

(57) ABSTRACT

Shoe molding for use with a door casing having a face with a given contour. The shoe molding includes a body extending from a free end to junction end, the body having a profile with a wall edge and a floor edge and a face extending between the edges. A junction cavity is defined in the junction end of the body extending in from the wall edge. The junction cavity defines an interior surface having a configuration which complements the given contour.

### FIELD OF THE INVENTION

This invention relates to molding. More particularly, the invention relates to shoe molding which provides a clean junction with a door casing.

### BACKGROUND OF THE INVENTION

When installing flooring, for example, laminate, vinyl, hardwood, in a previously finished space, there is a need to provide a clean look between the flooring and the base molding in the space. Typically, the installer utilizes one of two methods. The first method includes pulling off the existing base molding, installing the new flooring to the walls and then reinstalling the base molding over the edge of the new flooring. Most people do not choose to use this method because it can be difficult and time consuming. For example, the base molding may have been in place for many years with many layers of paint bonding it to the wall. It is difficult to remove the molding without damaging the molding and/or the walls. The installer can end up spending more time on the molding than it takes to install the new flooring.

The second method, which many people choose to avoid the above difficulties, leaves the existing base molding in place with the new flooring installed adjacent the existing base molding. To finish the look, shoe molding is installed against the base molding and the flooring, concealing any space therebetween. The term shoe molding is utilized to mean any molding having any desired profile which is installed against the base molding and the flooring. A common type of shoe molding is quarter-round molding; however, the shoe molding may have various other profiles.

While the shoe molding provides a generally clean finish, a less than desired look can occur where the shoe molding meets with the door casing. Referring to FIGS. 1 and 2, a door 10 is shown mounted to a door jamb 14 via a hinge 12. The door jamb 14 extends about the door 10 in an opening through the wall 16. Door casing 20 is positioned over the door jamb 14 and the wall 16 to conceal any gap that may be therebetween and to provide a finished look. The door casing 20 typically has a contoured face 23 and a flat edge 21. The casing flat edge 21 is typically thicker than the base molding 22 and the base molding 22 abuts against the flat edge 21.

As described above, after the new flooring is installed, shoe molding 30 may be applied between the base molding 22 and the flooring 24. As seen in FIGS. 1 and 2, the shoe molding 30 is installed to abut a remaining portion of the flat edge 21 of the door casing 20, but a portion of the shoe molding 30 extends out beyond the thickness of the door casing 20, creating a disjointed look. In the illustrated example, the abutting end 32 of the shoe molding 30 is back cut, for example, at a 45° angle in an effort to minimize the disjointed look, however, often the look remains unfinished.

Accordingly, there is a need for a shoe molding which provides a clean junction with the door casing.

### SUMMARY OF THE INVENTION

In at least one embodiment, the present disclosure provides shoe molding for use with a door casing having a face with a given contour. The shoe molding includes a body extending from a free end to junction end, the body having a profile with a wall edge and a floor edge and a face extending between the edges. A junction cavity is defined in the junction end of the body extending in from the wall edge. The junction cavity defines an interior surface having a configuration which complements the given contour.

In at least one embodiment, the present disclosure provides a molding assembly. The molding assembly includes a door casing having a flat edge and a face with a given contour. A base molding is secured relative to the door casing such that the base molding abuts the flat edge of the door casing. The assembly further includes shoe molding having a body extending from a free end to junction end. The body has a profile with a wall edge and a floor edge and a face extending between the edges. A junction cavity is defined in the junction end of the body extending in from the wall edge. The junction cavity defines an interior surface having a configuration which complements the given contour. The shoe molding is secured relative to the door casing and base molding such that the door casing is received in the junction cavity with the face extending along the interior surface.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a door opening with door casing, base molding and prior art shoe molding.

FIG. 2 is a cross sectional view along the line 2-2 in FIG. 1.

FIG. 3 is a perspective view of shoe molding in accordance with an embodiment of the disclosure.

FIGS. 4A, 4B, 4C, 4D are end elevation views illustrating various exemplary profiles for the shoe molding in accordance with embodiments of the disclosure.

FIG. 5 is a top plan view of the shoe molding of FIG. 3.

FIG. 6 is a perspective view illustrating the shoe molding of FIG. 3 installed with respect to a door casing, base molding and flooring.

FIG. 7 is a cross sectional view along the line 7-7 in FIG. 6.

FIG. 8 is a top plan view of shoe molding in accordance with another embodiment of the disclosure.

FIG. 9 is a perspective view illustrating the shoe molding of FIG. 8 installed with respect to a door casing, base molding and flooring.

FIG. 10 is a cross sectional view along the line 10-10 in FIG. 9.

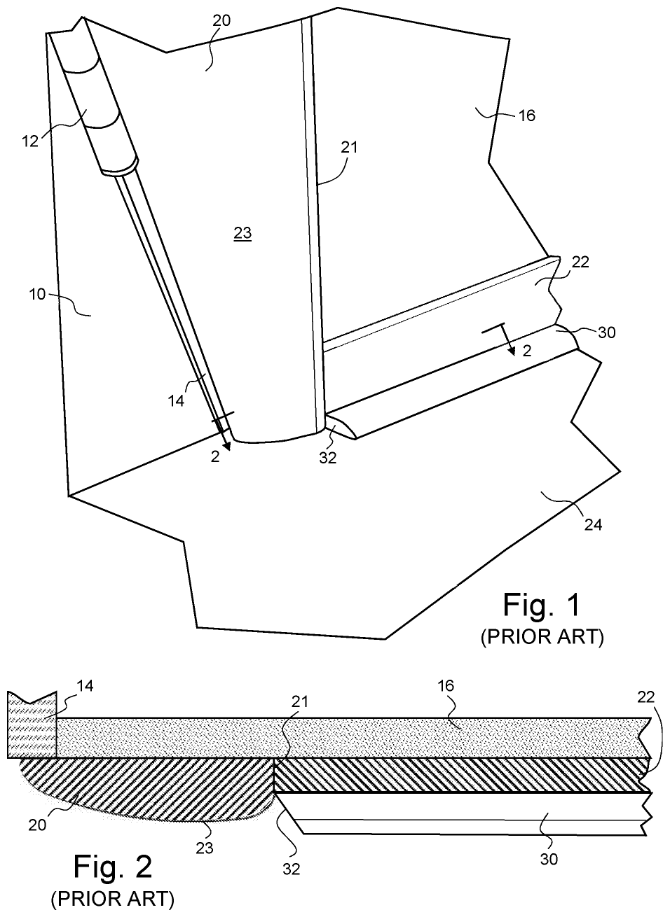

### DETAILED DESCRIPTION OF THE INVENTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein.

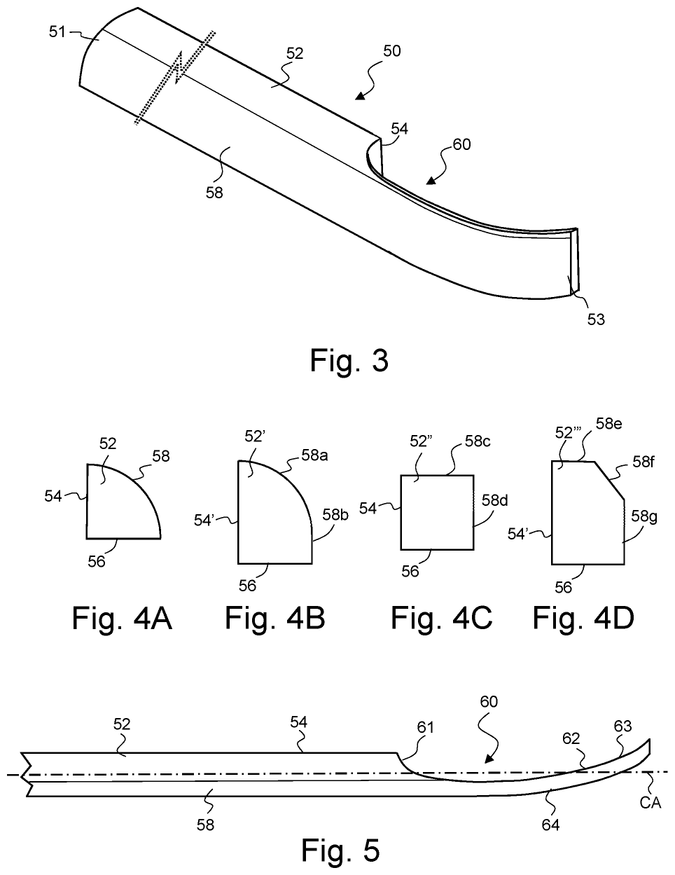

Referring to FIGS. 3-7, an exemplary embodiment of shoe molding 50 in accordance with an embodiment of the disclosure will be described. The shoe molding 50 has a body 52 which extends along a central axis CA from a free end 51 to a junction end 53. The length between the free end 51 and the junction end 53 may have any desired length provided that the junction end 53 defines the junction cavity, as will be described hereinafter, and the free end 51 has sufficient remaining length to be mitered or otherwise joined with additional length of corresponding common shoe molding. In one embodiment, the body 52 has a length of, for example, 6 inches which is sufficient to define the junction cavity 60 and allow for joining of the free end 51 with common shoe molding. While such allows the shoe molding 50 to accomplish a clean junction with the door casing while maintaining a relatively low cost, it is understood that the shoe molding 50 may be manufactured at a longer length, for example, 8 feet to minimize joints along the shoe molding within the space.

Referring to FIG. 4A, the body 52 of the shoe molding 50 has a profile having a wall edge 54 and a floor edge 56 with a face 58 extending therebetween. In the embodiment illustrated in FIG. 4A, the body 52 has a quarter-round configuration such that the wall edge 54 and floor edge 56 are of equal length and the face 58 has an arcuate configuration with a constant radius. It is understood that the molding body 52 may have various configurations and is not limited to a quarter-round configuration. For example, in the embodiment illustrated in FIG. 4B, the body 52′ is configured such that the wall edge 54′ is longer than the floor edge 56 and the face has an arcuate portion 58a and a flat portion 58b. In the embodiment illustrated in FIG. 4C, the body 52″ has a square configuration with the floor edge 54 and wall edge 56 of equal length and the face defined by two flat edges 58c and 58d at a right angle to one another and to the respective wall or floor edge. In the embodiment illustrated in FIG. 4D, the body 52′ is configured such that the wall edge 54′ is longer than the floor edge 56 and the face has three flat portions 58e, 58f and 58g, with portions 58e and 58g at right angles to the respective wall or floor edge and the portion 58f angle between the other two portions 58e, 58g. While various illustrative profiles have been described, the disclosure is not limited to such and the wall and floor edges 54, 56 may have various lengths and the face 58 may have various configurations including one or more portions having arcuate or flat configurations.

Referring to FIGS. 3 and 5, it is seen that the junction end 53 of the molding 50 defines a junction cavity 60 extending in from the wall edge 54 of the body 52. The junction cavity 60 extends into a portion of the floor edge 56 and the face 58. The junction cavity 60 has an interior surface 62 which is configured to complement the contour of the door casing contoured face 23. As used herein, the term complement does not require an exactly matching contour, but instead may include embodiments wherein the interior surface 62 has a contour such that the door casing 20 is received within the junction cavity 60 but one or more gaps exist between the door casing contoured face 23 and the interior surface 62. In such case, wood fill or the like (not shown) can be utilized to fill such gaps to provide a finished look. In the present embodiment, the interior surface 62 has a steep arc portion 61 and a generally continuous arc portion 63 which correspond to the contour of the door casing contoured face 23. In the illustrated embodiment, the exterior surface 64 of the junction end 53 has an arcuate configuration such that the junction end 53 curves toward the wall edge 54. Such a configuration maintains a consistent finish relative to the door casing 20 which is typically thicker along the flat edge 21 than the edge opposite thereto.

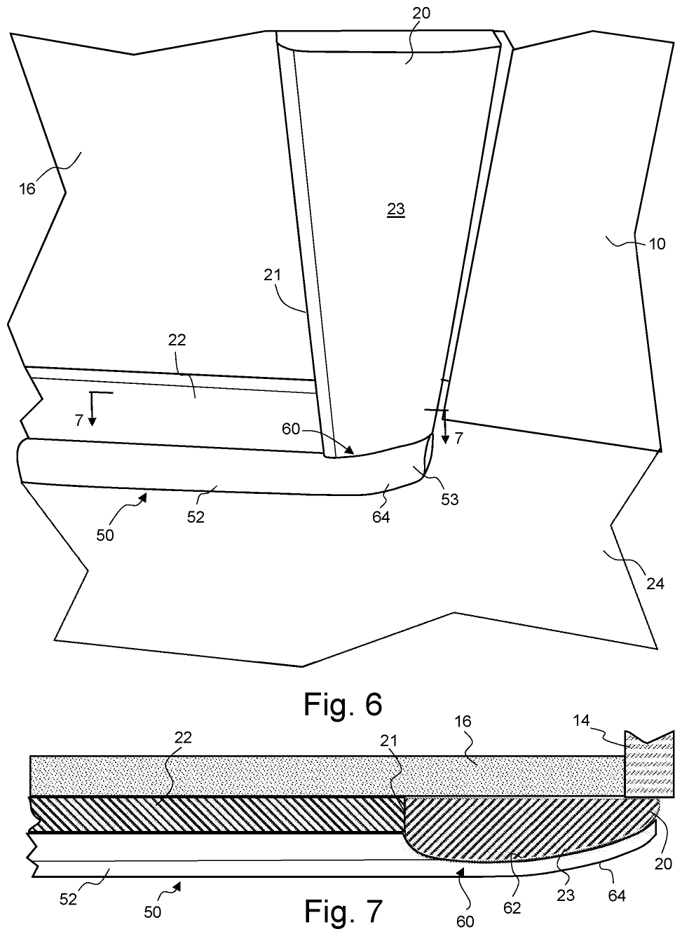

Referring to FIGS. 6 and 7, the shoe molding 50 is installed such that the door casing 20 is received in the junction cavity 60. Since the interior surface 62 has a configuration which complements the contour of the door casing contoured face 23, a clean finish is achieved between the shoe molding 50 and the door casing 20. It is understood that the shoe molding 50 may be formed with a left-hand or right-hand configuration so that the molding 50 may be applied on each side of the door 10. In some embodiments wherein the molding body 52 has a symmetrical configuration, for example the square configuration of the FIG. 4C, a single configuration may be useable on both sides of the door by flipping the molding end to end.

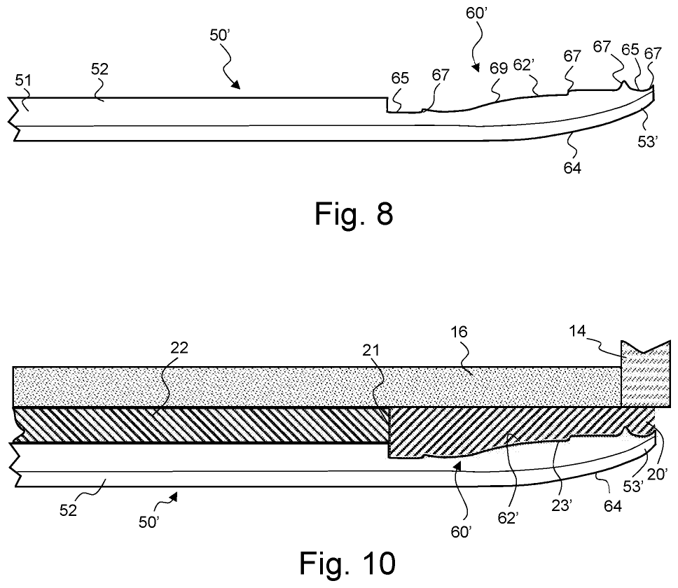

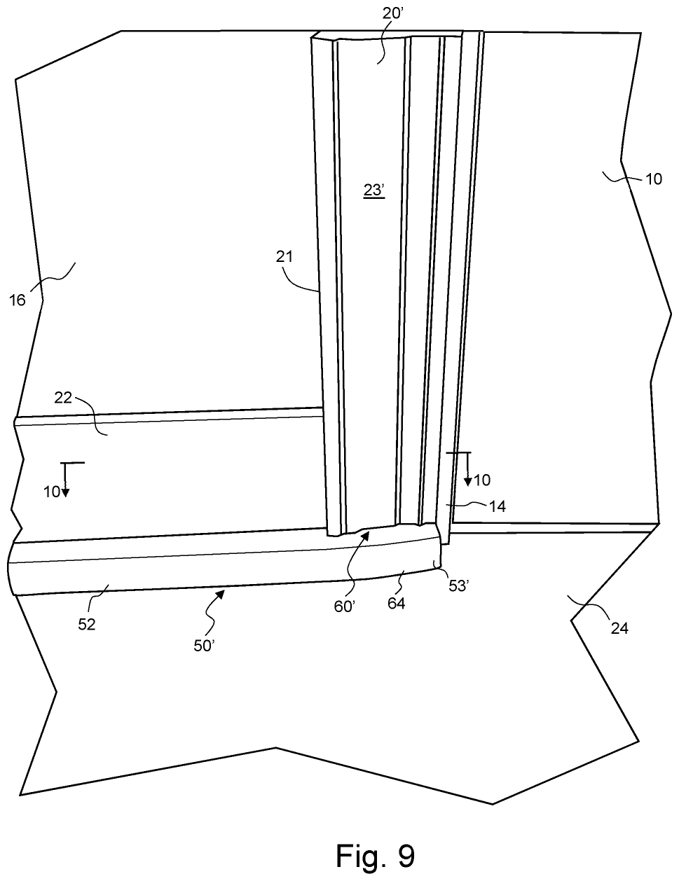

While the embodiment of FIGS. 3-7 shows the door casing 20 having a relatively simple arcuate face 23, the shoe molding of the disclosure is not limited to such. Referring to FIGS. 8-10, another illustrative embodiment of the shoe molding 50′ will be described. The molding 50′ of the present embodiment is configured for use with door casing 20′ having a more complex contoured face 23′ (see FIGS. 9 and 10). The shoe molding 50′ of the present embodiment is substantially similar to the previous embodiment and includes a body 52 extending from a free end 51 to a junction end 53′. The junction end 53′ again defines a junction cavity 60′, however, the interior surface 62′ of the present embodiment is more intricate than in the previous embodiment. More specifically, the interior surface 62′ defines a plurality of recesses 65, peaks 67 and arcuate surfaces 69 such that the interior surface 62′ complements the contour of the door casing contoured face 23′. As in the previous embodiment, the exterior surface 64 of the junction end 53′ may have an arcuate configuration such that the junction end 53′ curves toward the wall edge 54.

Referring to FIGS. 9 and 10, the shoe molding 50′ is installed such that the door casing 20′ is received in the junction cavity 60′. Since the interior surface 62′ has a configuration which complements the contour of the door casing contoured face 23′, a clean finish is achieved between the shoe molding 50′ and the door casing 20′. Again, the shoe molding 50′ may be formed with a left-hand or right-hand configuration if necessary.

While door casing 20, 20′ with two different face contours are illustrated, the disclosure is not limited to such. The junction cavity 60, 60′ may be formed with various interior surface 62, 62′ configurations to complement any desired door casing face contour.

The shoe molding 50, 50′ may be manufactured from various materials. For example, the molding 50, 50′ may be manufactured from solid or jointed wood. With such a material, the junction cavity 60, 60′ may be formed through various wood working processes, for example, cutting, chiseling, shaving, routing, planning, sanding or combinations thereof. Alternatively, the molding 50, 50′ may be manufactured from composite wood products, for example, medium density fiberboard, or from engineered materials, for example, high-density polyurethane, polystyrene or PVC. The junction cavity 60, 60′ of molding 50, 50′ manufactured from composite or engineered materials may be formed through wood working processes as described above or may be molded directly when the molding 50, 50′ is formed. It is further understood that the molding 50, 50′ of any of the materials may be formed with any desired surface finishes and/or styles to, for example, match the flooring, the base molding or the adjoining shoe molding.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

1. Shoe molding for use with a door casing having a given lateral width and a face with a given contour, the shoe molding comprising:
a body extending from a free end to junction end, the body having a profile with a wall surface and a floor surface and a face extending between the surfaces;
wherein a junction cavity is defined in the junction end of the body extending in from the wall surface, the junction cavity having a longitudinal length configured to be equal to or larger than the given lateral width and defining an interior surface having a configuration configured to complement the given contour.

2. The shoe molding according to claim 1 wherein the interior surface has a generally arcuate configuration.

3. The shoe molding according to claim 1 wherein the interior surface has a configuration defined by one or more recesses, one or more peaks, one or more arcuate portions or a combination thereof.

4. The shoe molding according to claim 1 wherein an exterior surface of the junction end has an arcuate configuration.

5. The shoe molding according to claim 4 wherein the junction end curves toward the wall surface.

6. The shoe molding according to claim 1 wherein the body has a cross-sectional profile with a quarter-round configuration.

7. The shoe molding according to claim 1 wherein the body has a cross-sectional profile such that the face has at least an arcuate portion and a flat portion.

8. The shoe molding according to claim 1 wherein the body has a cross-sectional profile with a square configuration.

9. The shoe molding according to claim 1 wherein the body has a cross-sectional profile such that the face has at least three portions extending at different angles relative to the wall surface.

10. A molding assembly comprising:
a door casing having a given lateral width and including a flat surface and a face with a given contour;
a base molding secured relative to the door casing such that the base molding abuts the flat surface of the door casing; and
shoe molding including:
a body extending from a free end to junction end, the body having a profile with a wall surface and a floor surface and a face extending between the surfaces;
wherein a junction cavity is defined in the junction end of the body extending in from the wall surface, the junction cavity having a longitudinal length equal to or larger than the given lateral width and defining an interior surface having a configuration which complements the given contour;
wherein the shoe molding is secured relative to the door casing and base molding such that the full lateral width of the door casing is received in the junction cavity with the face extending along the interior surface.

11. The molding assembly according to claim 10 wherein the given contour has a generally arcuate configuration and the interior surface has a generally arcuate configuration.

12. The molding assembly according to claim 10 wherein the interior surface has a configuration defined by one or more recesses, one or more peaks, one or more arcuate portions or a combination thereof.

13. The molding assembly according to claim 10 wherein an exterior surface of the junction end of the shoe molding has an arcuate configuration.

14. The molding assembly according to claim 10 wherein the junction end of the shoe molding curves toward the wall surface.

15. The molding assembly according to claim 10 wherein the shoe molding body has a cross-sectional profile with a quarter-round configuration.

16. The molding assembly according to claim 10 wherein the shoe molding body has a cross-sectional profile such that the face has at least an arcuate portion and a flat portion.

17. The molding assembly according to claim 10 wherein the shoe molding body has a cross-sectional profile with a square configuration.

18. The shoe molding according to claim 10 wherein the shoe molding body has a cross-sectional profile such that the face has at least three portions extending at different angles relative to the wall surface.
